(19) United States
(12) Patent Application Publication
(10) Pub. No.: US 2025/0105336 A1
(43) Pub. Date: Mar. 27, 2025

(54) ALL-SOLID RECHARGEABLE BATTERY PRESSURIZATION APPARATUS

(71) Applicant: SAMSUNG SDI CO., LTD., Yongin-si (KR)

(72) Inventors: Jinah LEE, Yongin-si (KR); Riyul KIM, Yongin-si (KR); Jinhee MOON, Yongin-si (KR); Hyeonjeong KIM, Yongin-si (KR); Jihyoung PARK, Yongin-si (KR); Jeonga MINN, Yongin-si (KR)

(21) Appl. No.: 18/828,084

(22) Filed: Sep. 9, 2024

(30) Foreign Application Priority Data
Sep. 21, 2023 (KR) 10-2023-0126575

(51) Int. Cl. H01M 10/04

(52) U.S. Cl. CPC H01M 10/0468

(57) ABSTRACT

An all-solid rechargeable battery pressurization apparatus includes: an upper pressure plate and a lower pressure plate that are spaced apart and face each other. The pressure plates are configured to contact with opposite surfaces of an all-solid cell to apply pressure to the surfaces. A pressurizing member fastens the upper and lower pressure plates to each other and is configured to provide pressure to the all-solid cell. A thickness reinforcing member is positioned in a central area of an upper surface of the upper pressure plate.

### CROSS-REFERENCE TO RELATED APPLICATION

This application claims priority to and the benefit of Korean Patent Application No. 10-2023-0126575 filed in the Korean Intellectual Property Office on Sep. 21, 2023, the entire contents of which are incorporated herein by reference.

### BACKGROUND

### 1. Field

The present disclosure relates to an all-solid rechargeable battery pressurization apparatus.

### 2. Description of the Related Art

Recently, as a risk of explosion of batteries that use liquid electrolytes has been reported, and development of all-solid rechargeable batteries is being conducted in view of the risk. An all-solid rechargeable battery is a battery in which all materials are made of solid, and refers to a battery in which a solid electrolyte is used. The all-solid rechargeable battery has advantages in that the battery is safe because there is no risk of explosion due to electrolyte leakage, is easy to manufacture as a thin battery, has a high energy density, and is capable of implementing large capacity.

The above information disclosed in this background section is only for enhancement of understanding of the background of the disclosure, and therefore it may contain information that does not form the prior art that is already known in this country to a person of ordinary skill in the art.

### SUMMARY

Embodiments attempt to provide an all-solid rechargeable battery pressurization apparatus that may uniformly pressurize all-solid cells to improve the performance of the all-solid cells.

However, the technical problem to be solved by the present disclosure is not limited to the above descriptions, and other objects not mentioned herein will be understood from the following description by those skilled in the art.

An embodiment provides an all-solid rechargeable battery pressurization apparatus that includes an upper pressure plate and a lower pressure plate that are spaced apart and face each other, with the upper pressure plate and the lower pressure plate being configured to contact with opposite surfaces of an all-solid cell to apply pressure to them. The apparatus also includes a pressurizing member that fastens the upper and lower pressure plates to each other and is configured to provide pressure to the all-solid cell, and a thickness reinforcing member positioned in a central area of an upper surface of the upper pressure plate.

A shape of the thickness reinforcing member may be one of a rhombus shape, a circular shape, an elliptical shape, and a quadrangular shape.

A thickness of the thickness reinforcing member may be greater than a thickness of the upper pressure plate.

The pressurizing member may include a plurality of fastening members positioned in an edge area of the upper pressure plate.

The pressurizing member may further include a plurality of pressure adjustment members respectively installed on the plurality of fastening members, with the plurality of adjustment members being configured to adjust pressure applied to the all-solid sell.

Each of the pressure adjustment members may include a coil spring.

Each of the fastening members may include a bolt and nut structure.

The upper pressure plate may include a plurality of fastening holes into which the plurality of fastening members are respectively fastened, and the plurality of fastening holes may be formed along the edge area of the upper pressure plate.

The upper pressure plate and the thickness reinforcing member may be integrally connected to each other.

The upper pressure plate and the thickness reinforcing member may be separable from each other.

According to the embodiments, by installing the thickness reinforcing member in the central area of the upper pressure plate that pressurizes the all-solid cell, the pressure deviation between the central area of the all-solid cell and the peripheral area of the all-solid cell may be minimized.

As described above, the all-solid cell may be uniformly pressurized to induce smooth interface contact inside the all-solid cell, thereby improving the performance of the all-solid cell.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 illustrates a cross-sectional view of an all-solid battery.

FIG. 2 illustrates a cross-sectional view of an all-solid battery including a precipitation-type negative electrode.

FIG. 3 illustrates a perspective view of an all-solid rechargeable battery pressurization apparatus according to an embodiment.

FIG. 4 illustrates a top plan view of FIG. 3.

FIG. 5 illustrates a side view of an upper pressure plate, a lower pressure plate, and a thickness reinforcing member of FIG. 3.

FIG. 6 illustrates a method of pressurizing an all-solid cell using an all-solid rechargeable battery pressurization apparatus according to an embodiment.

FIG. 7 to FIG. 9 illustrate top plan views of an all-solid rechargeable battery pressurization apparatus according to another embodiment.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

In addition, unless explicitly described to the contrary, the word “comprise” and variations such as “comprises” or “comprising” will be understood to imply the inclusion of stated elements but not the exclusion of any other elements.

In the drawings, the thicknesses of layers, films, panels, areas, regions, and the like are exaggerated for clarity, and like reference numerals designate like elements throughout the specification. It will be understood that when an element such as a layer, film, region, area or substrate is referred to as being “on” or “above” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface. Here, “or” is not to be construed as an exclusive meaning, and for example, “A or B” is construed to include A, B, A+B, and the like.

In the present specification, the term “combination thereof” refers to a mixture, a laminate, a copolymer, a blend, an alloy, a composite, or a reaction product of components.

Unless otherwise defined herein, the particle diameter may be an average particle diameter. In addition, the particle diameter indicates an average particle diameter (D₅₀) where a cumulative volume is about 50 volume % in a particle distribution. The average particle diameter (D₅₀) may be measured by a method well known to those skilled in the art, for example, by a particle size analyzer, or by a transmission electron microscopic image or a scanning electron microscopic image. Alternatively, a dynamic light-scattering measurement device is used to perform a data analysis, and the number of particles is counted for each particle size range, and from this, the average particle diameter (D₅₀) value may be easily obtained through a calculation. In addition, it may be measured by a laser diffraction method. It may be measured by the laser diffraction method as follows. The particles to be measured are dispersed in a dispersion medium and then introduced into a commercially available laser diffraction particle size measuring apparatus (for example, MT 3000 of Microtrac), ultrasonic waves of about 28 kHz are irradiated with an output of about 60 W, and an average particle diameter (D₅₀) in 50% reference of the particle size distribution in a measuring apparatus may be calculated.

Positive Electrode for all-Solid Rechargeable Battery

In an embodiment, there is provided a positive electrode for an all-solid rechargeable battery including a current collector and a positive electrode active material layer disposed on the current collector, wherein the positive electrode active material layer includes at least one of a positive electrode active material, a sulfide-based solid electrolyte, a binder, and a conductive material. However, the present disclosure is not limited thereto, and the positive electrode for the all-solid rechargeable battery may include more or less components than the above-described components.

In the embodiment, the positive electrode for the all-solid rechargeable battery is manufactured by applying a positive electrode composition including at least one of a positive electrode active material, a sulfide-based solid electrolyte, a binder, and a conductive material to a current collector, followed by drying and roll-pressing.

### Positive Active Material

The positive electrode active material may be applied without limitation as long as it is generally used in all-solid rechargeable batteries. For example, the positive electrode active material may be a compound capable of reversible intercalation and deintercalation of lithium, and the positive electrode active material may include a compound represented by any one of the following chemical formulas.

LiₐA_{1-b}X_{b}D₂ (0.90≤a≤1.8, 0≤b≤0.5);

LiₐA_{1-b}X_{b}O_{2-c}D_{c} (0.90≤a≤1.8, 0≤b≤0.5, 0≤c≤0.05);

LiₐE_{1-b}X_{b}O_{2-c}D_{c} (0.90≤a≤1.8, 0≤b≤0.5, 0≤c≤0.05);

LiₐE_{2-b}X_{b}O_{4-c}D_{c} (0.90≤a≤1.8, 0≤b≤0.5, 0≤c≤0.05);

LiₐNi_{1-b-c}CO_{b}X_{c}Dₐ (0.90≤a≤1.8, 0≤b≤0.5, 0≤c≤0.5, 0<α<2);

LiₐNi_{1-b-c}CO_{b}X_{c}O_{2-α}T_{α} (0.90≤a≤1.8, 0≤b≤0.5, 0≤c≤0.05, 0<α<2);

LiₐNi_{1-b-c}CO_{b}X_{c}O_{2-α}T₂ (0.90≤a≤1.8, 0≤b≤0.5, 0≤c≤0.05, 0<α<2);

LiₐNi_{1-b-c}Mn_{b}X_{c}D_{α} (0.90≤a≤1.8, 0≤b≤0.5, 0≤c≤0.05, 0<α<2);

LiₐNi_{1-b-c}Mn_{b}X_{c}O_{2-α}T_{α} (0.90≤a≤1.8, 0≤b≤0.5, 0≤c≤0.05, 0<α<2);

LiₐNi_{1-b-c}Mn_{b}X_{c}O_{2-α}T₂ (0.90≤a≤1.8, 0≤b≤0.5, 0≤c≤0.05, 0<α<2);

LiₐNi_{b}E_{c}G_{d}O₂ (0.90≤a≤1.8, 0≤b≤0.9, 0≤c≤0.5, 0.001≤d≤0.1);

LiₐNi_{b}CO_{c}Mn_{d}GₑO₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiₐCoG_{b}O₂ (0.90≤a≤1.8, 0.001≤b≤0.1);

LiₐMn_{1-b}G_{b}O₂ (0.90≤a≤1.8, 0.001≤b≤0.1);

LiₐMn₂G_{b}O₄ (0.90≤a≤1.8, 0.001≤b≤0.1);

LiₐMn_{1-g}G_{g}PO₄ (0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂POP₄₃ (0≤f≤2);

Li_{(3-f)}Fe₂PO₄₃ (0≤f≤2); and

LiₐFePO₄ (0.90≤a≤1.8).

In the above chemical formulas, A is selected from the group consisting of Ni, Co, Mn, and a combination thereof, X is selected from the group consisting of Al, Ni, Co, Mn, Cr, Fe, Mg, Sr, V, rare earth elements, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The positive electrode active material may be, for example, lithium cobalt oxide (often abbreviated LCO), lithium nickel oxide (often abbreviated LNO), lithium nickel cobalt oxide (often abbreviated LNCO), lithium nickel cobalt aluminum oxide (often abbreviated Li-NCA, LNCA, or NCA), lithium nickel cobalt manganese oxide (often abbreviated NCM), and lithium nickel manganese oxide (often abbreviated LNMO or NM), lithium manganese oxide (often abbreviated LMO), or lithium ferrous phosphate oxide (often abbreviated LFP).

The positive electrode active material may include a lithium nickel-based oxide represented by Chemical Formula 1 below, a lithium cobalt-based oxide represented by Chemical Formula 2 below, a lithium ferrous phosphate-based compound represented by Chemical Formula 3 below, or a combination thereof.

Liₐ₁Niₓ₁M¹_{y1}M²_{1-x1-y1}O₂ [Chemical Formula 1]

In Chemical Formula 1, 0.9≤a1≤1.8, 0.3≤x≤1, 0≤y1≤0.7, and M¹ and M² are each one or more elements independently selected from the group consisting of Al, B, Ba, Ca, Ce, Co, Cr, Cu, F, Fe, Mg, Mn, Mo, Nb, P, S, Si, Sr, Ti, V, W, and Zr.

Liₐ₂Coₓ₂M³₁₋ₓ₂O₂ [Chemical Formula 2]

In Chemical Formula 2, 0.9≤a2≤1.8, 0.6≤x2≤1, and M³ is one or more elements selected from the group consisting of Al, B, Ba, Ca, Ce, Cr, Cu, F, Fe, Mg, Mn, Mo, Nb, P, S, Si, Sr, Ti, V, W, and Zr.

Liₐ₃Feₓ₃M⁴₁₋ₓ₃PO₄ [Chemical Formula 3]

In Chemical Formula 3, 0.9≤a3≤1.8, 0.6≤x3≤1, and M⁴ is one or more elements selected from the group consisting of Al, B, Ba, Ca, Ce, Co, Cr, Cu, F, Fe, Mg, Mn, Mo, Nb, P, S, Si, Sr, Ti, V, W, and Zr.

An average particle diameter (D₅₀) of the positive electrode active material may be 1 μm to 25 μm, for example, 3 μm to 25 μm, 5 μm to 25 μm, 5 μm to 20 μm, 8 μm to 20 μm, or 10 μm to 18 μm. The positive electrode active material having the particle diameter range may be harmoniously mixed with other components in the positive electrode active material layer and may implement the high capacity and high energy density.

The positive electrode active material may be in the form of a secondary particle made by agglomeration of a plurality of primary particles, or may be in the form of a single particle. In addition, the positive electrode active material may be spherical or close to a spherical shape, or may be polyhedral or amorphous.

### Sulfide-Based Solid Electrolyte

The sulfide-based solid electrolyte may include, for example, Li₂S—P₂S₅, Li₂S—P₂S₅—LiX (X is a halogen element, for example I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each an integer, and Z is Ge, Zn, or Ga), Li₂S—GeS₂, Li₂S—SiS₂—Li₃PO₄, Li₂S—SiS₂-LiₚMO_{q} (p and q are integers, and M is P, Si, Ge, B, Al, Ga, or In), or a combination thereof.

The sulfide-based solid electrolyte may be obtained by, for example, mixing Li₂S and P₂S₅ at a molar ratio of 50:50 to 90:10 or 50:50 to 80:20 and optionally heat treating the mixture. Within the above mixing ratio range, the sulfide-based solid electrolyte having excellent ionic conductivity may be manufactured. Here, SiS₂, GeS₂, B₂S₃, and the like as other components may be included to further improve the ionic conductivity.

A mechanical milling or solution method may be applied as a method of mixing sulfur-containing raw materials to prepare the sulfide-based solid electrolyte. The mechanical milling is a method of particulating and mixing starting materials by putting the starting materials, a ball mill, and the like in a reactor and strongly stirring the mixture. When using the solution method, the solid electrolyte may be obtained as a precipitate by mixing the starting materials in a solvent. In addition, when heat treatment is performed after mixing, crystals of the solid electrolyte may become more robust and the ionic conductivity may be improved. As an example, the sulfide-based solid electrolyte may be prepared by mixing sulfur-containing raw materials and heat-treating the sulfur-containing raw materials twice. In this case, the sulfide-based solid electrolyte having high ionic conductivity and robustness may be prepared.

As an example, the sulfide-based solid electrolyte particles may contain argyrodite type sulfide. The argyrodite type sulfide may be expressed by, for example, LiₐM_{b}P_{c}S_{d}Aₑ (a, b, c, d, and e all are 0 or more to 12 or less, M is Ge, Sₙ, Si, or a combination thereof, A is F, Cl, Br, or I), and as a specific example, may be expressed by Chemical Formula of Li₇₋ₓPS₆₋ₓAₓ (x is 0.2 or more and 1.8 or less, and A is F, Cl, Br, or I). The argyrodite type sulfide may specifically be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

The sulfide-based solid electrolyte particles containing such argyrodite type sulfide may have high ionic conductivity close to the range of 10-4 to 10-2 S/cm, which is ionic conductivity of a typical liquid electrolyte at room temperature, and may form a tight bond between the positive active material and the solid electrolyte without causing the decrease in the ion conductivity, and further form a tight interface between the electrode layer and the solid electrolyte layer. The all-solid rechargeable battery containing this may improve the performance of the battery such as rate characteristics, coulombic efficiency, and lifespan characteristics.

The argyrodite type sulfide-based solid electrolyte may be prepared by, for example, mixing lithium sulfide, phosphorus sulfide, and optionally lithium halide. After mixing them, the heat treatment may be performed. The heat treatment may include, for example, two or more heat treatment steps.

The average particle size D₅₀ of the sulfide-based solid electrolyte particles according to an embodiment may be 5.0 μm or less and may be, for example, 0.1 μm to 5.0 μm, 0.1 μm to 4.0 μm, 0.1 μm to 3.0 μm, 0.5 μm to 2.0 μm, or 0.1 μm to 1.5 μm. Alternatively, depending on the location or purpose of use, the sulfide-based solid electrolyte particles may be small particles having the average particle size D₅₀ of 0.1 μm to 1.0 μm, or may be large particles having an average particle size D₅₀ of 1.5 μm to 5.0 μm. The sulfide-based solid electrolyte particles in this particle size range may effectively penetrate between the solid particles in the battery, and have excellent contactability with the electrode active material and the connectivity between the solid electrolyte particles. The average particle size of the sulfide-based solid electrolyte particles may be measured using a microscope image. For example, the particle size distribution may be obtained by measuring the size of about 20 particles in a scanning electron microscope image, and the D₅₀ may be calculated from the particle size distribution.

The content of the solid electrolyte in the positive electrode for the all-solid rechargeable battery may be 0.5 wt % to 35 wt % and may be, for example, 1 wt % to 35 wt %, 5 wt % to 30 wt %, and 8 wt % to 25 wt %, or 10 wt % to 20 wt %. This is the content relative to the total weight of the components in the positive electrode, and specifically, may be the content relative to the total weight of the positive electrode active material layer.

In the embodiment, the positive electrode active material layer contains 50 wt % to 99.35 wt % of positive electrode active material, 0.5 wt % to 35 wt % of sulfide-based solid electrolyte, and 0.1 wt % to 10 wt % of fluorinated resin binder, and 0.05 wt % to 5 wt % of vanadium oxide, based on 100 wt % of positive electrode active material layer. When this content range is satisfied, the positive electrode for the all-solid rechargeable battery maintains the high adhesion while maintaining the high capacity and high ionic conductivity, and viscosity of the positive electrode composition is maintained at an appropriate level, thereby improving the processability.

### Binder

The binder serves to appropriately bind positive electrode active material particles to each other and appropriately bind the positive electrode active material to the current collector. As a representative example of the binder, polyvinylalcohol, carboxymethylcellulose, hydroxypropylcellulose, diacetylcellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, an epoxy resin, nylon, or the like, may be used, but the binder is not limited thereto.

### Conductive Material

The positive electrode active material layer may further include a conductive material. The conductive material is used to provide conductivity to an electrode, and may include, for example, a carbon-based material such as natural graphite, artificial graphite, carbon black, acetylene black, Ketjen black, a carbon fiber, and a carbon nanotube; a metal-based material in the form of metal powder or metal fiber containing copper, nickel, aluminum, silver, and the like; a conductive polymer such as a polyphenylene derivative; or a combination thereof.

The conductive material may be included in an amount of 0.1 wt % to 5 wt %, or 0.1 wt % to 3 wt % with respect to a total weight of each component of the positive electrode for an all-solid battery, or with respect to the total weight of the first positive electrode active material layer. Within the above content range, the conductive material may improve electrical conductivity without deteriorating battery performance.

When the positive electrode active material layer further includes a conductive material, the positive electrode active material layer may include 45 wt % to 99.25 wt % of the positive electrode active material, 0.5 wt % to 35 wt % of the sulfide-based solid electrolyte, 0.1 wt % to 10 wt % of the fluorine-based resin binder, 0.05 wt % to 5 wt % of the vanadium oxide, and 0.1 wt % to 5 wt % of the conductive material with respect to 100 wt % of the positive electrode active material layer.

Note that the positive electrode for a lithium rechargeable battery may further include an oxide-based inorganic solid electrolyte, in addition to the solid electrolyte described above. The oxide-based inorganic solid electrolyte may include, for example, Li₁₊ₓTi₂₋ₓAl(PO₄)₃ [LTAP][0≤x≤4], Li_{1+x+y}AlₓTi₂₋ₓSi_{y}P_{3-y}O₁₂ [0<x<2, 0≤y<3], BaTiO₃, Pb(Zr,Ti)O₃ [PZT], Pb₁₋ₓLaₓZr_{1-y}Ti_{y}O₃ [PLZT][0≤x<1, 0≤y<1], PB(Mg₃Nb_{2/3})O₃—PbTiO₃ [PMN-PT], HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, garnet-based ceramics Li₃₊ₓLa₃M₂O₁₂ (M=Te, Nb, or Zr; x is an integer from 1 to 10), or a combination thereof.

### All-Solid Rechargeable Battery

An embodiment provides an all-solid rechargeable battery including the positive electrode described above, a negative electrode, and a solid electrolyte layer disposed between the positive electrode and the negative electrode. The all-solid rechargeable battery may be referred to as an all-solid battery or an all-solid lithium rechargeable battery.

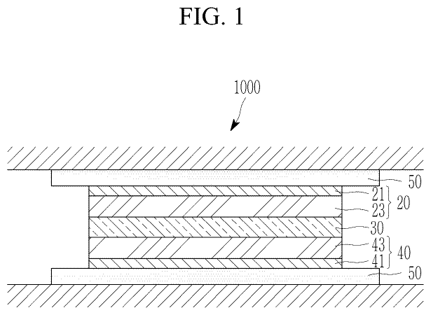

FIG. 1 illustrates a cross-sectional view of an all-solid battery.

Referring to FIG. 1, an all-solid battery 1000 may have a structure in which an electrode assembly in which a negative electrode 40 including a negative electrode current collector 41 and a negative electrode active material layer 43, a solid electrolyte layer 30, and a positive electrode 20 including a positive electrode active material layer 23 and a positive electrode current collector 21 are stacked is accommodated in a case such as a pouch. The all-solid battery 1000 may further include an elastic layer 50 on an outer side of at least one of the positive electrode 20 and the negative electrode 40. Although FIG. 1 shows one electrode assembly including the negative electrode 40, the solid electrolyte layer 30, and the positive electrode 20, an all-solid battery may be manufactured by stacking two or more electrode assemblies.

### Negative Electrode

The negative electrode for an all-solid battery may include, for example, a current collector and a negative electrode active material layer disposed on the current collector. The negative electrode active material layer includes a negative electrode active material and may further include a binder, a conductive material, and/or a solid electrolyte.

The negative electrode active material may include a material capable of reversibly intercalation/deintercalating lithium ions, lithium metal, an alloy of lithium metal, a material capable of being doped and undoped with lithium, or a transition metal oxide.

The material capable of reversibly intercalating/deintercalating lithium ions is a carbon-based negative electrode active material, and may include, for example, crystalline carbon, amorphous carbon, or a combination thereof. Examples of the crystalline carbon may include graphite such as amorphous, plate-like, flake-like, spherical or fibrous natural graphite or artificial graphite, and examples of the amorphous carbon may include soft carbon or hard carbon, mesophase pitch carbide, fired coke, and the like.

For the alloy of the lithium metal, an alloy of lithium and one or more metal selected from Na, K, Rb, Cs, Fr, Be, Mg, Ca, Sr, Si, Sb, Pb, In, Zn, Ba, Ra, Ge, Al and Sn may be used.

For the material capable of being doped or undoped with lithium, a Si-based negative electrode active material or an Sn-based negative electrode active material may be used. Examples of the Si-based negative electrode active material may include silicon, silicon-carbon composite, SiOₓ (0<x<2), and a Si-Q alloy (Q is an element selected from the group consisting of alkali metals, alkali earth metals, Group 13 elements, Group 14 elements, Group 15 elements, Group 16 elements, transition metals, rare-earth elements, and combinations thereof, but is not Si). Examples of the Sn-based negative electrode active material may include Sn, SnO₂, a Sn—R alloy (R is an element selected from the group consisting of alkali metals, alkali earth metals, Group 13 elements, Group 14 elements, Group 15 elements, Group 16 elements, transition metals, rare-earth elements, and combinations thereof, but is not Sn). In addition, a mixture of at least one thereof and SiO₂ may be used. The elements Q and R may be selected and used from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and a silicon particle and an amorphous carbon coating layer disposed on a surface of the core. The crystalline carbon may be artificial graphite, natural graphite, or a combination thereof. As the amorphous carbon precursor, coal-based pitch, mesophase pitch, petroleum-based pitch, coal-based oil, petroleum-based heavy oil, or polymer resin such as phenol resin, furan resin, and polyimide resin may be used. In this case, a content of silicon may be 10 wt % to 50 wt % with respect to a total weight of the silicon-carbon composite. In addition, a content of the crystalline carbon may be 10 wt % to 70 wt % with respect to the total weight of the silicon-carbon composite, and a content of the amorphous carbon may be 20 wt % to 40 wt % with respect to the total weight of the silicon-carbon composite. In addition, a thickness of the amorphous carbon coating layer may be 5 nm to 100 nm.

An average particle diameter (D₅₀) of the silicon particle may be 10 nm to 20 μm, and for example, 10 nm to 500 nm. The silicon particle may be present in an oxidized form, and in this case, an atomic content ratio of Si:O in the silicon particle, which indicates a degree of oxidation, may be 99:1 to 33:67. The silicon particle may be a SiOₓ particle, in which case a range of x in SiOₓ may be greater than 0 and less than 2. Here, the average particle diameter (D₅₀) is measured with a particle size analyzer using a laser diffraction method and refers to a diameter of a particle with a cumulative volume of 50% by volume in the particle size distribution.

The Si-based negative electrode active material or Sn-based negative electrode active material may be used by mixing with a carbon-based negative electrode active material. A mixing ratio of the Si-based negative electrode active material or Sn-based negative electrode active material and the carbon-based negative electrode active material may be 1:99 to 90:10 at a weight ratio.

The content of the negative electrode active material in the negative electrode active material layer may be 95 wt % to 99 wt % with respect to the total weight of the negative electrode active material layer.

In an exemplary embodiment, the negative electrode active material layer further includes a binder, and optionally, may further include a conductive material. A content of the binder in the negative electrode active material layer may be 1 wt % to 5 wt % with respect to the total weight of the negative electrode active material layer. In addition, when a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to adhere the negative electrode active material particles to each other well and also to adhere the negative electrode active material to the current collector well. The binder may include a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

Examples of the water-soluble binder may include a rubber-based binder or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluoro rubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a thickener capable of imparting viscosity may be used together, and the thickener may include, for example, a cellulose-based compound. The cellulose-based compound may include carboxymethyl cellulose, hydroxypropylmethyl cellulose, methyl cellulose, alkali metal salts thereof, or a combination thereof. As the alkali metal, Na, K, or Li may be used. An amount of the thickener used may be 0.1 to 3 parts by weight with respect to 100 parts by weight of the negative electrode active material.

The conductive material is used to provide conductivity to an electrode, and may include, for example, a carbon-based material such as natural graphite, artificial graphite, carbon black, acetylene black, Ketjen black, a carbon fiber, and a carbon nanotube; a metal-based material in the form of metal powder or metal fiber including copper, nickel, aluminum, silver, and the like; a conductive polymer such as a polyphenylene derivative; or a mixture thereof.

The negative electrode current collector may include one selected from a copper foil, a nickel foil, a stainless-steel foil, a titanium foil, a nickel foam, a copper foam, a polymer substrate coated with a conductive metal, and a combination thereof.

As another example, the negative electrode for an all-solid battery may be a precipitation-type negative electrode. A precipitation-type negative electrode refers to a negative electrode that does not include a negative electrode active material during assembling of a battery but in which lithium metal or the like is precipitated during charging of the battery and serves as a negative electrode active material.

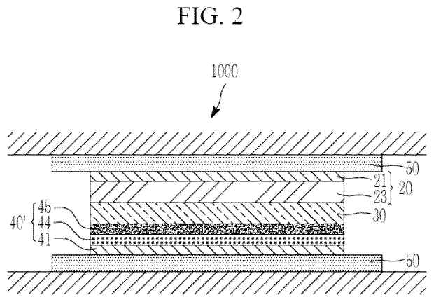

FIG. 2 illustrates a cross-sectional view of an all-solid battery including a precipitation-type negative electrode.

Referring to FIG. 2, a precipitation-type negative electrode 40′ may include a current collector 41 and a negative electrode coating layer 45 disposed on the current collector. In an all-solid battery having the precipitation-type negative electrode 40′, initial charging begins in the absence of a negative electrode active material. Then, during the charging, lithium metal with a high density or the like is precipitated between the current collector 41 and the negative electrode coating layer 45 and forms a lithium metal layer 44, which may serve as a negative electrode active material. Accordingly, in an all-solid battery that has been charged once or more, the precipitation-type negative electrode 40′ may include the current collector 41, the lithium metal layer 44 disposed on the current collector, and the negative electrode coating layer 45 disposed on the metal layer. The lithium metal layer 44 refers to a layer of lithium metal or the like precipitated during the charging process of the battery and may be called a metal layer or a negative electrode active material layer.

The negative electrode coating layer 45 may include metal, a carbon material, or a combination thereof that serves as a catalyst.

The metal may include, for example, gold, platinum, palladium, silicon, silver, aluminum, bismuth, tin, zinc, or a combination thereof, and may be composed of one selected therefrom or an alloy of more than one thereof. When the metal is present in the form of a particle, an average particle diameter (D₅₀) thereof may be about 4 μm or less, for example, 10 nm to 4 μm.

The carbon material may be, for example, crystalline carbon, amorphous carbon, or a combination thereof. The crystalline carbon may be, for example, natural graphite, artificial graphite, a mesophase carbon microbead, or a combination thereof. The amorphous carbon may be, for example, carbon black, activated carbon, acetylene black, Denka black, Ketjen black, or a combination thereof.

When the negative electrode coating layer 45 includes both the metal and the carbon material, a mixing ratio of the metal and the carbon material may be, for example, 1:10 to 2:1 at a weight ratio. In this case, the precipitation of lithium metal may be effectively promoted and the characteristics of the all-solid battery may be improved. The negative electrode coating layer 45 may include, for example, a carbon material on which catalyst metal is supported, or a mixture of metal particles and carbon material particles.

The negative electrode coating layer 45 may include, for example, the metal and amorphous carbon, and in this case, the precipitation of lithium metal may be effectively promoted.

The negative electrode coating layer 45 may further include a binder, and the binder may be a conductive binder. Furthermore, the negative electrode coating layer 45 may further include general additives such as a filler, a dispersant, and an ion conductive material.

A thickness of the negative electrode coating layer 45 may be, for example, 100 nm to 20 μm, 500 nm to 10 μm, or 1 μm to 5 μm.

For example, the precipitation-type negative electrode 40′ may further include a thin film on the surface of the current collector, that is, between the current collector and the negative electrode coating layer. The thin film may contain an element that may form an alloy with lithium. The element that may form an alloy with lithium may be, for example, gold, silver, zinc, tin, indium, silicon, aluminum, bismuth, and the like, which may be used alone or as an alloy of more than one thereof. The thin film may further planarize a precipitation shape of the lithium metal layer 44 and further improve the characteristics of the all-solid battery. The thin film may be formed by, for example, a vacuum deposition method, a sputtering method, a plating method, or the like. The thin film may have, for example, a thickness ranging from 1 nm to 500 nm.

### Solid Electrolyte Layer

The solid electrolyte layer 30 may include a sulfide-based solid electrolyte, an oxide-based solid electrolyte, and the like. The specific description of the sulfide-based solid electrolyte and the oxide-based solid electrolyte are the same as above.

In one example, the solid electrolyte included in the positive electrode 20 and the solid electrolyte included in the solid electrolyte layer 30 may include the same compound or different compounds. For example, when both the positive electrode 20 and the solid electrolyte layer 30 include an argyrodite-type sulfide-based solid electrolyte, the overall performance of the all-solid rechargeable battery may be improved. Furthermore, as an example, when both the positive electrode 20 and the solid electrolyte layer 30 include the coated solid electrolyte described above, the all-solid rechargeable battery may implement excellent initial efficiency and life characteristics while implementing a high capacity and a high energy density.

Meanwhile, the average particle diameter (D₅₀) of the solid electrolyte included in the positive electrode 20 may be smaller than the average particle diameter (D₅₀) of the solid electrolyte included in the solid electrolyte layer 30. In this case, the overall performance may be improved by maximizing the energy density of the all-solid battery and increasing the mobility of lithium ions. For example, the average particle diameter (D₅₀) of the solid electrolyte included in the positive electrode 20 may be 0.1 μm to 1.0 μm, or 0.1 μm to 0.8 μm, and the average particle diameter (D₅₀) of the solid electrolyte included in the solid electrolyte layer 30 may be 1.5 μm to 5.0 μm, 2.0 μm to 4.0 μm, or 2.5 μm to 3.5 μm. When the above particle diameter ranges are satisfied, the energy density of the all-solid rechargeable battery is maximized and the transfer of lithium ions is facilitated, making it possible to suppress resistance and thus to improve the overall performance of the all-solid rechargeable battery. Here, the average particle diameter (D₅₀) of the solid electrolyte may be measured with a particle size analyzer using a laser diffraction method. Alternatively, a particle size distribution may be obtained by measuring sizes of about 20 particles selected from a microscope image such as a scanning electron microscope, and a D₅₀ value may be calculated from the particle size distribution.

The solid electrolyte layer may further include a binder, in addition to the solid electrolyte. In this case, for the binder, a styrene butadiene rubber, polytetrafluoroethylene, polyvinylidene fluoride, polyethylene, an acrylate-based polymer, or a combination thereof may be used, but the present disclosure is not limited thereto, and any binder used in the art may be used. The acrylate-based polymer may be, for example, butyl acrylate, polyacrylate, polymethacrylate, or a combination thereof.

The solid electrolyte layer may be formed by adding a solid electrolyte to a binder solution, coating a base film with the solution, and drying the resultant. The solvent for the binder solution may be isobutyl isobutyrate, xylene, toluene, benzene, hexane, or a combination thereof. A process of forming the solid electrolyte layer is widely known in the art, and therefore, a detailed description will be omitted.

A thickness of the solid electrolyte layer may be, for example, 10 μm to 150 μm.

The solid electrolyte layer may further include an alkali metal salt, and/or an ionic liquid, and/or a conductive polymer.

The alkali metal salt may be, for example, a lithium salt. A content of the lithium salt in the solid electrolyte layer may be 1 M or more, for example, 1 M to 4 M. In this case, the lithium salt may improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato)borate (LiDFOB), lithium bis(trifluoro methanesulfonyl)imide, LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

Furthermore, the lithium salt may be an imide-based salt. For example, the imide-based lithium salt may include lithium bis(trifluoro methanesulfonyl)imide, LiTFSI, LiN(SO₂CF₃)₂), lithium bis(fluorosulfonyl)imide, LiFSI, LiN(SO₂F)₂). The lithium salt may maintain or improve ionic conductivity by appropriately maintaining chemical reactivity with an ionic liquid.

The ionic liquid refers to a salt or a room temperature molten salt that has a melting point equal to or lower than a room temperature, is in a liquid state at room temperature, and is composed of only ions.

The ionic liquid may be a compound including a) one or more cations selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, and triazolium-based cations and a mixture thereof, and b) BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, for example, one or more selected from the group consisting of N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example, 10:90 to 90:10, 20:80 to 90:10, 30:70 to 90:10, 40:60 to 90:10, or 50:50 to 90:10. The solid electrolyte layer that satisfies the above ranges may maintain or improve ionic conductivity by improving the electrochemical contact area with the electrode. Accordingly, the energy density, discharge capacity, rate characteristics, and the like of the all-solid battery may be improved.

The all-solid battery may include a unit cell having a structure of a positive electrode/a solid electrolyte layer/a negative electrode, a bi-cell structure having a structure of a positive electrode/a solid electrolyte layer/a negative positive electrode/a solid electrolyte layer/a positive electrode, or a stacked battery in which a structure of a unit battery is repeated.

A shape of the all-solid battery is not particularly limited, and may be, for example, a coin shape, a button shape, a sheet shape, a stack shape, a cylindrical shape, a flat shape, or the like. In addition, the all-solid battery may also be applied to large-sized batteries used in electric vehicles, and the like. For example, the all-solid battery may also be used in a hybrid vehicle such as a plug-in hybrid electric vehicle (PHEV). Furthermore, it may be used in fields that require a large amount of power storage, and for example, may also be used to an electric bicycle, an electric tool or the like.

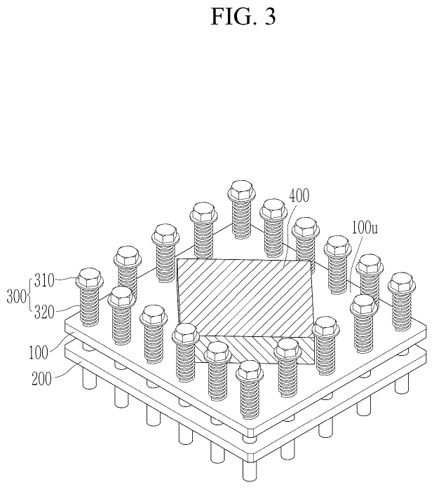

Hereinafter, an all-solid rechargeable battery pressurization apparatus according to an embodiment will be described with reference to FIG. 3 to FIG. 5.

An all-solid rechargeable battery pressurization apparatus according to an embodiment of the present disclosure may be used in an all-solid rechargeable battery manufacturing process, used for evaluation of the manufactured all-solid rechargeable battery, or used as a pressurization apparatus when using the all-solid rechargeable battery.

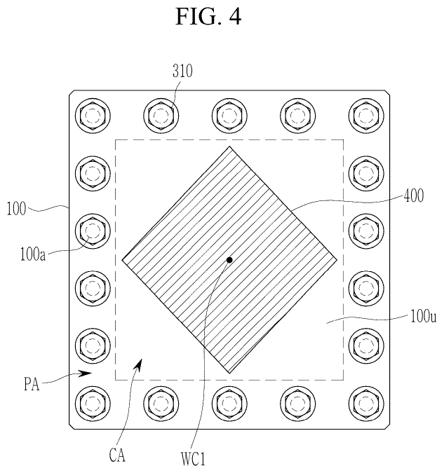

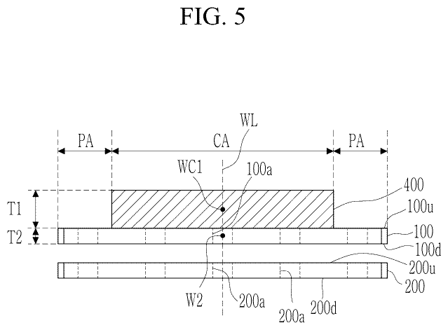

FIG. 3 illustrates a perspective view of an all-solid rechargeable battery pressurization apparatus according to an embodiment, FIG. 4 illustrates a top plan view of an upper pressure plate of FIG. 3, and FIG. 5 illustrates a side view of the upper and lower pressure plates of FIG. 3.

As shown in FIG. 3 to FIG. 5, the all-solid rechargeable battery pressurization apparatus according to the embodiment includes an upper pressure plate 100, a lower pressure plate 200, a pressurizing member 300, and a thickness reinforcing member 400.

The upper pressure plate 100 and the lower pressure plate 200 have the same size and may be spaced apart from each other by a predetermined distance. The upper pressure plate 100 and the lower pressure plate 200 may contact opposite surfaces of an all-solid cell 10 and pressurize both of the surfaces. That is, the upper pressure plate 100 may contact an upper surface 10u of the all-solid cell 10 to pressurize the upper surface 10u of the all-solid cell 10, and the lower pressure plate 200 may contact a lower surface 10d of the all-solid cell 10 to pressurize the lower surface 10d of the all-solid cell 10.

The pressurizing member 300 may fasten the upper pressure plate 100 and the lower pressure plate 200 to each other and provide pressure to pressurize the all-solid cell 10.

The pressurizing member 300 may include a plurality of fastening members 310 and a plurality of pressure adjustment members 320.

The plurality of fastening members 310 may be installed in an edge area PA of the upper pressure plate 100. Each of the fastening members 310 may include bolt and nut structures. However, the fastening members 310 are not necessarily limited thereto, and fastening members 310 with various structures are possible.

The upper pressure plate 100 may have a plurality of fastening holes 100a to which the plurality of fastening members 310 are fastened. The plurality of fastening holes 100a may be formed along the edge area PA of the upper pressure plate 100.

The plurality of pressure adjustment members 320 may be installed on the plurality of fastening members 310 to adjust the pressure applied to the all-solid cell 10. Each of the pressure adjustment members 320 may include a coil spring. However, the pressure adjustment members 320 are not necessarily limited thereto, and pressure adjustment members 320 having various structures are possible.

The thickness reinforcing member 400 may be installed in the central area CA of the upper surface of the upper pressure plate 100. The shape of the thickness reinforcing member 400 may be a rhombus shape. However, the shape of the thickness reinforcing member 400 is not necessarily limited thereto, and will be described in detail using various embodiments in the description below.

The thickness T1 of the thickness reinforcing member 400 may be greater than the thickness T2 of the upper pressure plate 100. Accordingly, pressure may be easily provided to the upper pressure plate 100.

The center of gravity WC1 of the thickness reinforcing member 400 may be positioned on the same line WL as the center of gravity W2 of the upper pressure plate 100.

The upper pressure plate 100 and the thickness reinforcing member 400 may be separable from each other. However, the present disclosure is not necessarily limited in this regard, and the upper pressure plate 100 and the thickness reinforcing member 400 may be integrally connected to each other.

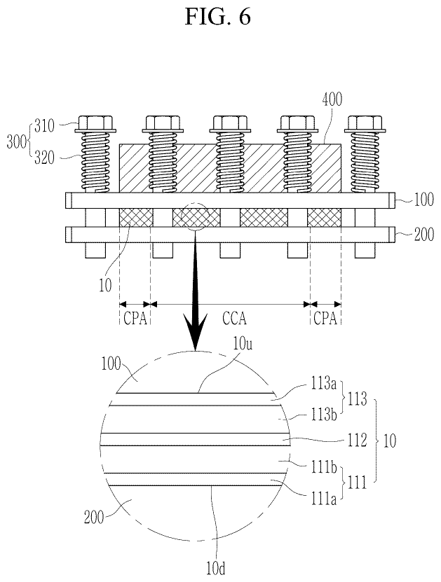

FIG. 6 illustrates a method of pressurizing an all-solid cell using an all-solid rechargeable battery pressurization apparatus according to an embodiment.

Referring to FIG. 6, the all-solid cell 10 is disposed between the upper pressure plate 100 and the lower pressure plate 200, the upper surface 10u of the all-solid cell 10 is brought into contact with the lower surface 100d of the upper pressure plate 100, and the lower surface 10d of the all-solid cell 10 is brought into contact with the upper surface 200u of the lower pressure plate 200. Then, the all-solid cell 10 is pressurized using the pressurizing member 300.

The all-solid cell 10 may include a positive electrode 111, a solid electrolyte layer 112, and a negative electrode 113. Here, the positive electrode 111 may include a cathode, and the negative electrode 113 may include an anode. The positive electrode 111 may include a positive electrode current collecting layer 111a and a positive electrode active material layer 111b disposed on one surface of the positive electrode current collecting layer 111a. The negative electrode 113 may include a negative electrode current collecting layer 113a and a negative electrode coating layer 113b disposed on one surface of the negative electrode current collecting layer 113a. The solid electrolyte layer 112 may be disposed between the positive electrode active material layer 111b and the negative electrode coating layer 113b.

The upper pressure plate 100 and the lower pressure plate 200 may be fastened using the fastening members 310 of the pressurizing member 300 to press opposite surfaces of the all-solid cell 10, and the pressure on both surfaces of the all-solid cell 10 may be adjusted using the pressure adjustment member 320.

Since the fastening member 310 is installed in the edge area PA of the upper pressure plate 100, the pressure may be provided greater to the peripheral area CPA of the all-solid cell 10 than to the central area CCA of the all-solid cell 10. However, in the present embodiment, by installing the thickness reinforcing member 400 in the central area CA of the upper surface 100u of the upper pressure plate 100, the difference between the pressure applied to the central area CCA of the all-solid cell 10 and the pressure applied to the peripheral area CPA of the all-solid cell 10 may be minimized. In this way, by uniformly pressurizing the solid state cell 10, smooth interface contact inside the all-solid cell 10 is induced at an interface between the positive electrode containing lithium and the solid electrolyte layer, thereby improving the mobility of lithium ions to improve the performance of the all-solid cell 10.

In the case of a large-area all-solid cell, the difference in pressure applied to areas of the all-solid cell 10 may vary significantly. However, in the present embodiment, by installing the thickness reinforcing member 400, it is possible to apply uniform pressure to the central area CCA and the peripheral area CPA of the large-area all-solid cell, thereby minimizing the difference in pressure applied inside the large-area all-solid cell, which thereby improves the performance of the large-area all-solid cell.

In the present embodiment, the reinforcing member has a rhombus shape, but other embodiments include thickness reinforcing members having various other shapes.

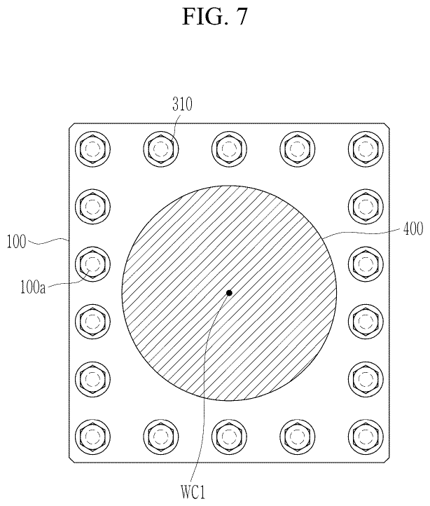

An all-solid rechargeable battery pressurization apparatus according to other embodiments of the present disclosure will be described in detail with reference to FIG. 7 to FIG. 9.

FIG. 7 to FIG. 9 illustrate top plan views of an all-solid rechargeable battery pressurization apparatus according to other embodiments. The other embodiments shown in FIG. 7 to FIG. 9 are substantially the same as the embodiment shown in FIG. 3 to FIG. 6 except for the shape of the thickness reinforcing member, so repeated description thereof will be omitted.

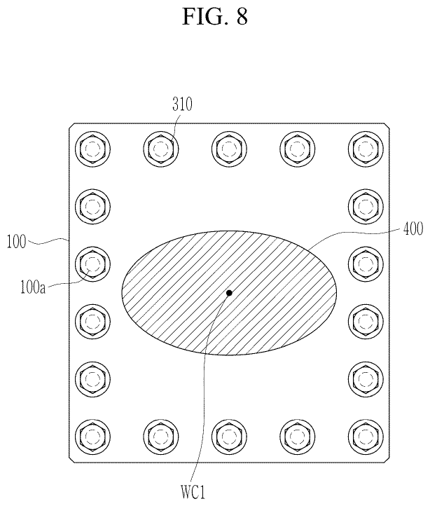

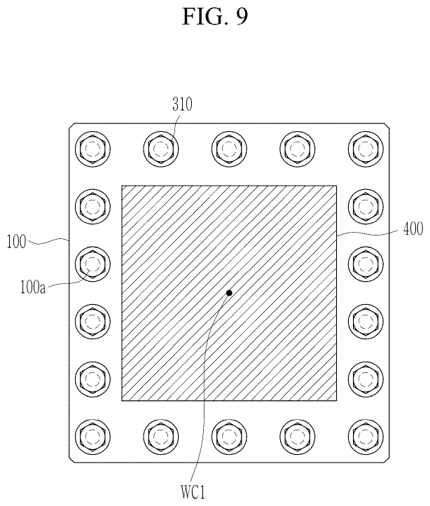

As shown in FIG. 7, the thickness reinforcing member 400 of an all-solid rechargeable battery according to another embodiment of the present disclosure may have a circular shape. In addition, as shown in FIG. 8, the thickness reinforcing member 400 of an all-solid rechargeable battery according to another embodiment of the present disclosure may have an elliptical shape. In addition, as shown in FIG. 9, the thickness reinforcing member 400 of an all-solid rechargeable battery according to another embodiment of the present disclosure may have a quadrangular shape.

The center of gravity WC1 of the thickness reinforcing members 400 shown in FIG. 7 to FIG. 9 may be positioned on the same line WL as the center of gravity WC2 of the upper pressure plate 100. Here, the line WL refers to a virtual line connecting the areas affected by gravity.

As described above, by installing the thickness reinforcing member 400 having a shape such as a circular shape, an elliptical shape, or a quadrangular shape in the central area CA of the upper pressure plate 100 that pressurizes the all-solid cell 10, the difference in pressure applied to the central area CCA of the all-solid cell 10 and the peripheral area CPA of the all-solid cell 10 may be minimized.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

<Description of symbols>

| | |
|---|---|
| 10: all-solid cell | 100: upper pressure plate |
| 200: lower pressure plate | 300: pressurizing member |
| 310: fastening member | 320: pressure adjustment member |
| 400: thickness reinforcing member | |

What is claimed is:

1. An all-solid rechargeable battery pressurization apparatus comprising:
an upper pressure plate and a lower pressure plate that are spaced apart and face each other, the upper pressure plate and the lower pressure plate being configured to contact with opposite surfaces of an all-solid cell to apply pressure to the surfaces;
a pressurizing member that fastens the upper and lower pressure plates to each other and is configured to provide pressure to the all-solid cell; and
a thickness reinforcing member positioned in a central area of an upper surface of the upper pressure plate.

2. The all-solid rechargeable battery pressurization apparatus of claim 1, wherein a shape of the thickness reinforcing member is one of a rhombus shape, a circular shape, an elliptical shape, and a quadrangular shape.

3. The all-solid rechargeable battery pressurization apparatus of claim 2, wherein a thickness of the thickness reinforcing member is greater than a thickness of the upper pressure plate.

4. The all-solid rechargeable battery pressurization apparatus of claim 2, wherein the pressurizing member includes a plurality of fastening members positioned in an edge area of the upper pressure plate.

5. The all-solid rechargeable battery pressurization apparatus of claim 4, wherein the pressurizing member further includes a plurality of pressure adjustment members respectively installed on the plurality of fastening members, the plurality of adjustment members being configured to adjust pressure applied to the all-solid cell.

6. The all-solid rechargeable battery pressurization apparatus of claim 5, wherein each of the pressure adjustment members includes a coil spring.

7. The all-solid rechargeable battery pressurization apparatus of claim 5, wherein each of the fastening members includes a bolt and nut structure.

8. The all-solid rechargeable battery pressurization apparatus of claim 4, wherein the upper pressure plate includes a plurality of fastening holes into which the plurality of fastening members are respectively fastened, and
wherein the plurality of fastening holes are formed along the edge area of the upper pressure plate.

9. The all-solid rechargeable battery pressurization apparatus of claim 1, wherein the upper pressure plate and the thickness reinforcing member are integrally connected to each other.

10. The all-solid rechargeable battery pressurization apparatus of claim 1, wherein the upper pressure plate and the thickness reinforcing member are separable from each other.
